(19) United States
(12) Patent Application Publication
(10) Pub. No.: US 2010/0001497 A1
(43) Pub. Date: Jan. 7, 2010

(54) INFLATOR

(76) Inventors: Masayuki YAMAZAKI, Hyogo (JP); Shingo Oda, Hyogo (JP)

Correspondence Address: BIRCH STEWART KOLASCH & BIRCH, PO BOX 747, FALLS CHURCH, VA, 22040-0747, US

(21) Appl. No.: 12/491,882

(22) Filed: Jun. 25, 2009

Related U.S. Application Data
(60) Provisional application No. 61/079,014, filed on Jul. 8, 2008.

(30) Foreign Application Priority Data
Jul. 4, 2008 (JP) 2008-175204

(51) Int. Cl. B60R 21/26

(52) U.S. Cl. 280/736

(57) ABSTRACT

An inflator employing a pressurized gas and used for a restraining system of a vehicle, including an adsorbent and a gas charged into a gas charging chamber of the inflator, the gas being adsorbed to the adsorbent and also charged into a space in which the adsorbent does not exist.

This nonprovisional application claims priority under 35 U.S.C. §119(a) on Patent Application No. 2008-175204 filed in Japan on 4 Jul. 2008 and 35 U.S.C. §119(e) on U.S. Provisional Application No. 61/079,014 filed on 8 Jul. 2008, which are incorporated by reference.

### BACKGROUND OF INVENTION

1. Field of Invention

The present invention relates to an inflator for a restraint system of a vehicle.

2. Description of Related Art

An inflator is attached to a restraining device of an automobile such as a driving seat or front passenger seat air bag apparatus, a side collision air bag apparatus, a curtain air bag apparatus, a knee bolster air bag apparatus, and also to an apparatus attached to the exterior of the vehicle for protecting pedestrians, and so on. Known inflators include an inflator that uses a solid gas generating agent for generating gas (a pyrotechnic-type inflator), an inflator that discharges gas stored under pressure (a stored-type inflator), and an inflator that uses both a solid gas generating agent and pressurized gas (a hybrid-type inflator).

Of these inflators, the stored-type inflator and the hybrid-type inflator employ a bottle for storing the pressurized gas, and the pressurized gas has to be stored in the bottle without leaking over the life time (10 years, for example) of the vehicle. To secure pressure resistance, the thickness of the bottle has to be increased.

Furthermore, to activate a restraining system such as an air bag apparatus, a certain amount (number of moles) of gas should be supplied, but when a corresponding amount (number of moles) of gas is stored as the pressurized gas, the size of the bottle increases, leading to an increase in the weight of the inflator itself.

When gas is charged into a bottle having a predetermined volume in a large amount, the thickness of the bottle has to be increased to secure pressure resistance. Further, when the gas is charged without increasing a charging pressure, the interior volume of the bottle (the dimensions of the bottle) should be increased, and therefore an inflator that uses pressurized gas is invariably confronted with problems relating to the weight and volume of the bottle. In an apparatus attached to a vehicle, there is particular strong demand for a reduction in weight with a view to improving fuel efficiency, but inflators using pressurized gas have not been able to respond to this demand sufficiently so far.

JP-A No. 61-144495 discloses introducing an adsorbent into a sealed high-pressure gas container and charging gas into the container at a lower pressure or charging a larger amount of gas at an unchanged pressure. JP-A 61-144495 discloses nothing about an inflator for a restraint in vehicle.

### SUMMARY OF INVENTION

The present invention provides an inflator employing a pressurized gas and used for a restraining system of a vehicle, including an adsorbent and a gas charged into a gas charging chamber of the inflator, the gas being adsorbed to the adsorbent and also charged into a space in which the adsorbent does not exist.

The present invention is, in other words, an inflator, used for a restraining system of a vehicle, comprising an adsorbent and a pressurized gas, charged into a gas-charging chamber of the inflator, part of the gas being adsorbed onto the adsorbent and the other part being charged into a space in which the adsorbent does not exist.

### BRIEF DESCRIPTION OF DRAWINGS

The present invention will become more fully understood from the detailed description given hereinbelow and the accompanying drawings which are given by way of illustration only, and thus are not limitative of the present invention and wherein:

FIG. 1 shows a sectional view taken in a length direction of an inflator according to the present invention; and

FIG. 2 shows a sectional view taken in the length direction of an inflator according to another embodiment of the present invention.

### DETAILED DESCRIPTION OF INVENTION

An inflator that uses pressurized gas needs a bottle that is thick enough to withstand high pressure, but as a result, it is impossible to respond to demand for a reduction in weight. A reduction in the weight of the inflator leads to a reduction in the overall weight of the automobile, enabling an improvement in the fuel efficiency of the automobile and a corresponding reduction in fuel consumption. As a result, the amount of generated CO₂ can be reduced, which is of great social significance.

The present invention provides an inflator for a restraining system of a vehicle, which uses an adsorbent to reduce a pressurized gas charging volume or enable the pressurized gas to be charged at a lower pressure, whereby reductions in weight and the amount of required members can be achieved.

By employing the adsorbent in this manner, a larger amount of gas can be charged than a case where the gas is simply charged into the inflator. As a result, the volume and the thickness of the gas charging chamber can be reduced. Hence, overall reductions in size and weight can be achieved even taking into consideration the increase in weight caused by charging the adsorbent.

Further, the mass of a single inflator can be reduced, and therefore the number of inflators can be increased while maintaining the total mass of the restraining device installed in the vehicle. As a result, the restraining performance can be improved.

Furthermore, when the inflator according to the present invention is used in a plurality in a single vehicle, the mass per inflator can be reduced, and therefore the overall mass of the restraining devices installed in the vehicle can also be reduced, leading to a reduction in the overall weight of the vehicle. In recent years, it has become ordinary to attach a plurality of restraining devices to a single vehicle, and therefore the contribution thereof to a reduction in the weight of the vehicle is large. Accordingly, highly favorable effects can be obtained in relation to fuel efficiency and energy consumption.

The present invention preferably provides the inflator, wherein the inflator uses the pressurized gas and a combustion gas generated through combustion of a gas generating agent. That is, the invention inflator may further contain a gas generating agent so that the inflator generates the pressurized gas and a combustion gas generated through combustion of a gas generating agent.

The present invention further preferably provides the inflator, wherein the adsorbent takes a lump form.

To facilitate a charging operation, the adsorbent preferably takes a lump form. However, the adsorbent may be particle-shaped, rod-shaped, disk-shaped, and so on, depending on the interior structure of the gas charging chamber of the inflator and so on.

The present invention further preferably provides the inflator, wherein the inflator has a filter that is provided in a gas discharge passage to trap the adsorbent.

When the filter is used, the adsorbent is prevented from being discharged through a gas discharge port and flowing into the air bag. Note that an inflator employing pressurized gas typically has a filter for trapping fragments of the rupturable plate, and therefore, by employing the filter described above, discharge of the adsorbent can be prevented without increasing the mass of the inflator.

With the inflator according to the present invention, the overall size and/or weight of the inflator can be reduced while maintaining a constant gas generation amount. Therefore, the overall weight of a vehicle installed with an air bag apparatus or the like employing the inflator can be reduced, enabling an improvement in fuel efficiency and a reduction in a CO₂ discharge amount resulting from a reduction in energy consumption.

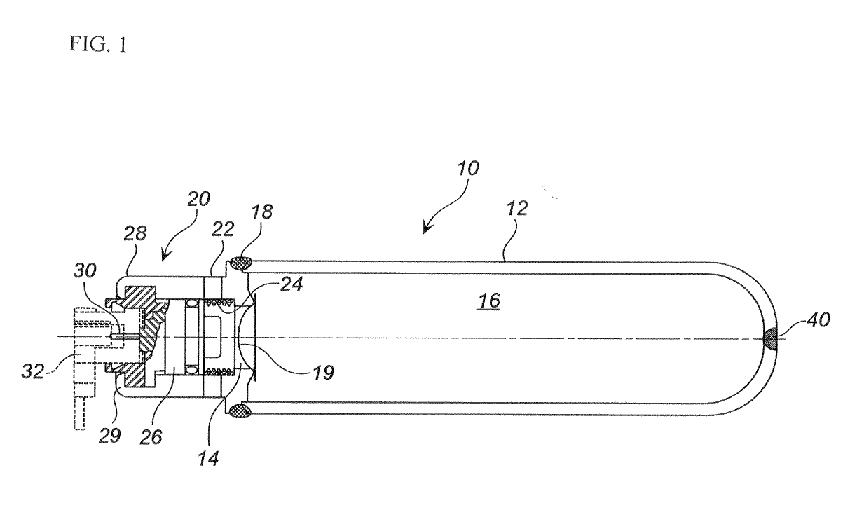

### (1) Inflator of FIG. 1

An embodiment of the present invention will be described below using FIG. 1. FIG. 1 is a sectional view taken in the length direction of a curtain inflator 10 according to the present invention. The basic structure of the inflator shown in FIG. 1 is identical to that of an inflator shown in FIG. 1 of JP-A No. 2002-145004.

An inflator housing 12 has an opening portion 14 in one end side and is closed in the other end side, whereby an interior space thereof forms a gas charging chamber 16. A cross-section of the inflator housing 12 in the width direction is circular, and the opening portion 14 takes an identical circular shape.

A diffuser portion 20 is fixed to the opening portion 14 of the inflator housing 12 by welding at a joint portion 18. An outer shell of the diffuser portion 20 is formed by a diffuser housing 28, and the diffuser portion 20 includes a gas discharge port 22 for discharging pressurized gas flowing out through the opening portion 14 to the outside upon activation, and a wire mesh filter 24 provided to cover the gas discharge port 22 from the inside. Thus, the pressurized gas always passes through the filter 24 before being discharged to the outside through the gas discharge port 22.

The opening portion 14 of the inflator housing 12 is closed by a rupturable plate 19 attached to the diffuser portion 20 such that prior to activation, the gas charging chamber 16 of the inflator housing 12 is maintained in a high-pressure airtight state and the diffuser portion 20 is at ambient pressure.

An igniter 26 including an ignition charge is provided in the diffuser portion 20 in order to rupture the rupturable plate 19. The igniter 26 is attached to the diffuser portion 20 by being fitted into the diffuser housing 28, and fixed by crimping an end portion 29 of the diffuser housing 28. The numeral 30 denotes a conductive pin for carrying a current to the igniter 26. The numeral 31 denotes an O-ring. The numeral 32, which is indicated by a broken line, denotes a connector that is connected to a power supply when the inflator 10 is installed in a vehicle.

In the inflator 10, an adsorbent and a pressurized gas constituted by an inert gas, not shown in the drawing, are charged into the gas charging chamber 16. The adsorbent may be charged densely, or a space in which the adsorbent is not charged may be secured.

As long as the adsorbent is porous and capable of adsorbing gas, activated carbon, zeolite, carbon black, silica gel, and so on, which can be obtained from various raw materials, may be used as the adsorbent.

The adsorbent is preferably provided in lump form, while a powder form adsorbent is undesirable. There are no particular limitations on the shape thereof, and any shape that can be charged densely, such as a particle shape, a spherical shape, a circular column shape, a circular column shape having a penetrating hole in the length direction, and soon, may be employed. When a lump form adsorbent is used, the diameter (maximum diameter in the case of a shape other than a spherical shape) thereof is preferably adjusted to approximately 1 mm to 10 mm. Further, when a lump form adsorbent is used, the diameter thereof is adjusted to ensure that the adsorbent can be trapped by the filter 24. In addition, a combination of a plurality of disk-shaped molded bodies or donut-shaped molded bodies having an outer diameter that corresponds to the inner diameter of the gas charging chamber 16, a combination of a plurality of rod-shaped molded bodies having a length that corresponds to the length of the gas charging chamber 16, or a single molded body having a substantially identical shape to the internal shape of the gas charging chamber 16 may be employed.

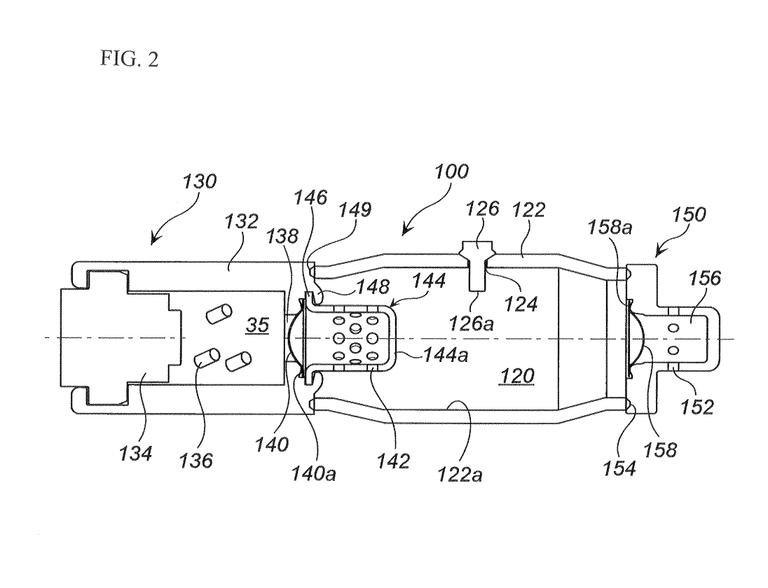

When the adsorbent is charged densely in a position of contact with the rupturable plate 19, rupturing of the rupturable plate 19 may not proceed smoothly, and therefore a cap 144 used in an inflator 100 shown in FIG. 2 may be attached.

The pressurized gas is charged into the pressurized gas charging chamber 16 into which the adsorbent is charged through a small hole formed in an end portion of the inflator housing 12. A seal pin is then fitted into the small hole, after which the small hole is sealed by welding or the like. The numeral 40 indicates a state in which the small hole has been sealed by welding.

Alternatively, the adsorbent may be charged into a separate container, whereupon the gas is blown into the container and adsorbed by the adsorbent at a low temperature. In so doing, the absorbent including the pressurized gas may be provided within the inflator housing 12 prior to attachment of the diffuser portion 20. Here, charging may be performed through a charging hole formed in the inflator housing 12, whereupon the hole is closed. When this charging method is applied, supplementary gas may be charged through the small hole in the inflator housing 12 following assembly if necessary, and if supplementary charging is not required, the small hole need not be formed in the inflator housing 12.

In the inflator 10, the pressurized gas in the pressurized gas charging chamber 16 is adsorbed to and held on the adsorbent and also the gas exists in gaps between the adsorbent or spaces in which the adsorbent is not charged.

Next, an operation performed by the curtain inflator 10 when activated will be described. When installed in a vehicle, the curtain inflator 10 is provided as a system combining activation signal output means including an impact sensor and a control unit, a module case in which the curtain inflator 10 and a curtain-shaped air bag are accommodated, and so on. When the vehicle receives an impact, a signal is received from the impact sensor of the system, and as a result, the igniter 26 is activated, causing the ignition charge to ignite and burn such that the rupturable plate 19 is ruptured.

When the rupturable plate 19 ruptures, the opening portion 14 opens, and therefore the pressure in the pressurized gas charging chamber 16 decreases rapidly. Accordingly, the gas adsorbed in the adsorbent is discharged rapidly. The discharged gas passes through the filter 24 and is then discharged through the gas discharge port 22 to inflate the curtain air bag. At this time, a discharge pressure of the pressurized gas is controlled by the gas discharge port 22 such that combustion residue of the ignition charge and fragments of the rupturable plate 19 are prevented from being discharged into the interior of the curtain air bag by the filter 24. Due to the filter 24, the adsorbent is not discharged through the gas discharge port 22.

### (2) Inflator of FIG. 2

Another embodiment will now be described using FIG. 2. FIG. 2 is a sectional view taken in the axial direction of an inflator. The basic structure of the inflator shown in FIG. 2 is identical to that of an inflator shown in FIG. 1 of JP-A No. 2003-226219.

The inflator 100 includes a pressurized gas chamber 120, a gas generator 130, and a diffuser portion 150.

An outer shell of the pressurized gas chamber 120 is formed by a tubular pressurized gas chamber housing 122. An identical adsorbent to that of the inflator 10 shown in FIG. 1 is charged into the pressurized gas chamber (pressurized gas charging chamber) 120 and also a gas such as argon or helium is charged therein. The pressurized gas chamber housing 122 is symmetrical in the axial direction and the radial direction, and hence the orientation thereof in the axial direction and the radial direction need not be adjusted at the time of assembly.

A pressurized gas charging hole 124 is formed in a side face of the pressurized gas chamber housing 122, and the pressurized gas charging hole 124 is closed by a pin 126 once the pressurized gas has been charged.

The gas generator 130 includes an ignition device (an electric igniter) 134 and a gas generating agent 136 accommodated in a gas generator housing 132, and is connected to one end side of the pressurized gas chamber 120. The gas generator housing 132 and the pressurized gas chamber housing 122 are resistance-welded at a joint portion 149. When the inflator 100 is incorporated into an air bag system, the ignition device 134 is connected to an external power supply via a connector and a wire.

An example of the gas generating agent 136 can include 34 wt % of nitroguanidine serving as a fuel, 56 wt % of strontium nitrate serving as an oxidizer, and 10 wt % of sodium carboxymethyl-cellulose serving as a binder and has a discharged gas temperature of 700 to 1630° C. Strontium oxide (melting point 2430° C.) is generated as combustion residue when the gas generating agent 136 having the above composition is burned. Therefore, the combustion residue hardens to a lump form (slag form) without entering a molten state.

A first communication hole 138 formed between the pressurized gas chamber 120 and the gas generator 130 is closed by a first rupturable plate 140 that deforms into a bowl shape upon reception of the pressure of the pressurized gas, and thus the interior of the gas generator 130 is held at ambient pressure. The first rupturable plate 140 is resistance-welded to the gas generator housing 132 at a peripheral edge portion 140a.

The first rupturable plate 140 is covered by a cap 144 having a gas ejection hole 142 from the pressurized gas chamber 120 side. By attaching the cap 144 so as to cover the first rupturable plate 140, combustion gas generated upon combustion of the gas generating agent 136 always passes through the cap 144 before being ejected through the gas ejection hole 142. The adsorbent is not charged into the cap 144, and the size of the gas ejection hole 142 is adjusted to ensure that the adsorbent does not enter the cap 144.

The cap 144 has a flange portion 146, an opening peripheral edge portion of which is bent outward, and the cap 144 is fixed by crimping a part (a crimped portion) 148 of the gas generator housing 132 at the flange portion 146.

The diffuser portion 150, which includes a gas discharge hole 152 for discharging the pressurized gas and the combustion gas, is connected to the other end of the pressurized gas chamber 120, and the diffuser portion 150 and pressurized gas chamber housing 122 are resistance-welded at a joint portion 154. If necessary, a filter made of wire mesh or the like may be disposed in the diffuser portion 150 to trap combustion residue and the adsorbent.

A second communication hole 156 formed between the pressurized gas chamber 120 and the diffuser portion 150 is closed by a second rupturable plate 158 that deforms into a bowl shape upon reception of the pressure of the pressurized gas, and thus the interior of the diffuser portion 150 is held at ambient pressure. The second rupturable plate 158 is resistance-welded to the diffuser portion 150 at a peripheral edge portion 158a. Note that an identical member to the cap 144 may be attached so as to cover the second rupturable plate 158, thereby ensuring that the adsorbent does not contact the second rupturable plate 158.

Next, an operation of the inflator 100 shown in FIG. 2 when incorporated into an air bag system installed in an automobile will be described.

When the automobile receives an impact during a collision, the igniter 134 is activated and ignited by the activation signal output means, whereby the gas generating agent 136 is burned so as to generate high-temperature combustion gas. At this time, the melting point of the combustion residue that is generated by combustion of the gas generating agent 136 is more than the discharge temperature of the gas generated from the gas generating agent 136, and therefore the combustion residue is unlikely to melt and can be held in a solid state.

When the internal pressure of the gas generator 130 is raised by the high-temperature combustion gas, the first rupturable plate 140 ruptures such that the combustion gas including the combustion residue flows into the cap 144 and is ejected through the gas ejection hole 142. At this time, a temperature difference between the pressurized gas carried on the adsorbent in the pressurized gas chamber 120 and the combustion gas is large, and therefore the combustion gas is cooled rapidly, causing the high-temperature combustion residue to cool and coagulate. The ejected combustion gas impinges on the adsorbent or an inner wall 122a of the pressurized gas chamber housing 122, and therefore the combustion residue is unlikely to be discharged to the outside of the inflator 100.

Next, the second rupturable plate 158 is ruptured due to an increase in the internal pressure of the pressurized gas chamber 120, and therefore the pressurized gas and the combustion gas pass through the second communication hole 156 and are discharged through the gas discharge hole 152 so as to inflate the air bag.

Note that even if the high-temperature gas generated through combustion of the gas generating agent 136 upon activation of the igniter 134 comes into contact with the adsorbent (activated carbon, for example), the adsorbent does not burn since no oxygen exists in the pressurized gas chamber 120 and the oxygen in the gas generator 130 and the oxidizer of the gas generating agent 136 have been consumed.

### EXAMPLES

### Example 1, Comparative Example 1

The inflator 10 shown in FIG. 1 and Table 1 was manufactured. In Example 1, an adsorbent and argon were charged into the inflator housing 12, and in Comparative Example 1, only argon was charged into the inflator housing 12. Note that the inflator housings used in Example 1 and Comparative Example 1 have identical outer diameters.

Activated carbon having a density of 0.001 g/cm³ and an adsorbable argon ratio of 1.34×10⁻⁵ mol/mm³ was employed as the adsorbent. In Example 1, the argon charging pressure was set at 10 MPa and a coefficient of compressibility was set at 1.24. In the first comparative example, the argon charging pressure was set at 58 MPa and a coefficient of compressibility was set at 0.95.

TABLE 1

| | | Comparative |
|---|---|---|
| | Example 1 | Example. 1 |
| charged gas type | Ar100% | Ar100% |
| (a) number of moles of | 4/160 | 4/160 |
| charged gas/gas mass(g) | | |
| gas charging pressure (Mpa) | 10 | 58 |
| outer diameter of gas | 40 | 40 |
| charging chamber (mm) | | |
| (b) absorbent charge amount (g) | 300 | — |
| length of inflator housing (mm) | 254 | 242 |
| thickness of inflator | 0.6 | 3.4 |
| housing (mm) | | |
| (c)mass of inflator housing | 170 | 850 |
| alone(g) | | |
| total mass of (a), (b)and (c) (g) | 630 | 1010 |

| | |
|---|---|
| mass of Comparative Example | 1010 − 630 = 380 |
| 1-mass of Example 1 (g) | |

An identical number of moles of gas were used in Example 1 and Comparative Example 1, but in Example 1, the gas was adsorbed to and held on the adsorbent, and it was therefore possible to reduce the charging pressure. Hence, as is evident from Table 1, it was possible in Example 1 to reduce the thickness of the inflator housing.

In Example 1, a required amount of the adsorbent had to be charged, and therefore the length (the interior volume) of the inflator housing had to be increased beyond that of Comparative Example 1. However, by reducing the thickness, it was possible to achieve a reduction in the total mass of the inflator housing despite the mass increase caused by the adsorbent.

### Example 2, Comparative Example 2

The inflator 10 shown in FIG. 1 and Table 2 was manufactured similarly to Example 1 and Comparative Example 1.

TABLE 2

| | | Comparative |
|---|---|---|
| | Example 2 | Example 2 |
| charged gas type | Ar100% | Ar100% |
| (a) number of moles of | 4/160 | 4/160 |
| charged gas/gas mass(g) | | |
| gas charging pressure (Mpa) | 10 | 10 |
| outer diameter of gas | 40 | 40 |
| charging chamber (mm) | | |
| (b) absorbent charge amount (g) | 300 | — |
| length of inflator housing (mm) | 250 | 780 |
| thickness of inflator | 0.6 | 0.6 |
| housing (mm) | | |
| (c)mass of inflator housing | 170 | 500 |
| alone (g) | | |
| total mass of (a), (b) and (c) (g) | 630 | 660 |

| | |
|---|---|
| length of Comparative | 780 − 250 = 530 |
| Example 2 - length of Example | |
| 2 (mm) | |
| mass of Comparative Example | 660 − 630 = 30 |
| 2 - mass of Example 2 (g) | |

In Example 2 and Comparative Example 2, the gas charging pressure and the thickness of the inflator housing were set identically, and it was therefore possible to achieve a reduction in length (a reduction in interior volume). Hence, it was possible to achieve a reduction in total mass even taking into consideration the increase caused by the mass of the adsorbent.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An inflator, employing a pressurized gas and used for a restraining system of a vehicle, comprising an adsorbent and a gas, charged into a gas-charging chamber of the inflator, the gas being adsorbed to the adsorbent and also charged into a space in which the adsorbent does not exist.

2. The inflator according to claim 1, wherein the inflator uses the pressurized gas and a combustion gas generated through combustion of a gas generating agent.

3. The inflator according to claim 1, wherein the adsorbent takes a lump form.

4. The inflator according to claim 1, wherein the inflator has a filter that is provided in a gas discharge passage to trap the adsorbent.

5. The inflator according to claim 2, wherein the adsorbent takes a lump form.

6. The inflator according to claim 2, wherein the inflator has a filter that is provided in a gas discharge passage to trap the adsorbent.
